(19) United States
(12) Patent Application Publication
(10) Pub. No.: US 2004/0205219 A1
(43) Pub. Date: Oct. 14, 2004

(54) Virtual active network for live streaming media

(76) Inventors: Wen-Syan Li, Fremont, CA (US); Kasim Selcuk Candan, Tempe, AZ (US); Divyakant Agrawal, Goleta, CA (US); Murat Kantarcioglu, W. Lafayette, IN (US)

Correspondence Address: GRAY CARY WARE & FREIDENRICH LLP, 2000 UNIVERSITY AVENUE, E. PALO ALTO, CA, 94303-2248, US

(21) Appl. No.: 10/676,386

(22) Filed: Sep. 30, 2003

Related U.S. Application Data
(60) Provisional application No. 60/448,684, filed on Feb. 19, 2003.

(51) Int. Cl. G06F 15/16

(52) U.S. Cl. 709/231

(57) ABSTRACT

A virtual active network architecture of proxy servers for providing streaming media data over wide area networks includes forming a hierarchical structure of proxy servers for multiplexing and delivering the live streaming media, and dynamically reconfiguring the hierarchical structure based upon user population, user distribution, usage patterns and network conditions. Separate virtual active networks sharing proxy servers in different hierarchical structures are formed for different streams of media data, and the different hierarchical structures are dynamically reconfigured independently of one another. Redistribution and consolidation of data paths through the hierarchical structures is performed by the proxy network coordinator in response to messages from the proxy servers of a hierarchical structure.

This application claims the benefit of U.S. Provisional Application No. 60/448,684, filed Feb. 19, 2003.

### BACKGROUND OF THE INVENTION

Delivery of streaming media and wide-area dissemination of data pose significant challenges in wide area networks such as the Internet. The large amount of bandwidth and other resources required to deliver streaming media limits the number of concurrent users. Without appropriate multicasting mechanisms, network routes may become quickly congested as a result of the same stream being delivered from its source to many recipients. The problem is compounded in wide area networks in which the load is bursty and dynamic, such as in the case of live streaming media. This can result in delays, interruptions and loss of data.

Current approaches to solve these problems include IP level multicasting to build multicast routes from sources to sinks. This approach, however, has difficulties because of incompatibilities of various network elements of the Internet service providers and the like. As a result, some alternative approaches attempt to build overlay networks on top of the underlying physical network, and to use application level routing and multicasting through logical links between network elements, such as proxies. This approach addresses the incompatibility and interoperability problems at the physical network layer, but does not provide an appropriate mechanism for distributing load to optimize network bandwidth. Currently, each user request for data results in a data flow connection being set-up between the data origin server and the user. However, current network infrastructures do not effectively handle congestion in the network and servers, or the changes in distribution of end user populations. Therefore, media or data streams can suffer from network congestion on delivery paths. Accordingly, an approach to this problem has been to use proxy caching for media data delivery. This approach treats media data as an object to cache at edge caches for delivery to nearby end users. It is useful for video clips and the like, but is not suitable for live broadcasting of streaming media. Other approaches use pre-configured proxy networks. However, these do not efficiently accommodate changes in system load or user distributions, and do not efficiently handle live streaming media which has bursty traffic conditions at the beginning of an event.

There is a need for systems and methods that address these and other problems of efficiently distributing live streaming media and other data in wide area networks, and it is to these ends that the present invention is directed.

### SUMMARY OF THE INVENTION

The invention affords an application level proxy network architecture and method for distribution of live streaming data and wide area data dissemination that aggregates routes between data sources and sinks. The invention provides a hierarchical overlay network structure that may be automatically and dynamically adjusted based upon conditions such as user population distribution, usage patterns, and network conditions. The system architecture affords reliable and high quality live streaming media delivery, lower server resource requirements at the content provider sites, reduced inter-ISP traffic, application level routing for rapid deployment and cost-effective media data delivery.

In one aspect the invention affords a method of distributing streaming data in a wide area network that has an overlay network of proxy servers that comprises activating the proxy servers to form a hierarchical structure comprising multiple tiers of proxy servers with respect to a data stream from a corresponding data source to distribute the data stream to a plurality of users. The proxy servers are activated in the multiple tiers based upon the users and in order to provide predetermined network operating conditions. The hierarchical structure is dynamically reconfigured as users change in order to maintain the predetermined network operating condition.

In another aspect, the invention distributes streaming media in a wide area network by activating proxy servers of an overlaid network to form first and second hierarchical structures in multiple tiers to distribute corresponding first and second data streams to first and second groups of users, respectively. The first and second hierarchical structures share one or more proxy servers of the overlaid network of proxy servers, and the numbers of tiers and proxy servers in each tier of the first and second hierarchical structures is based upon the first and second groups of users, respectively. The hierarchical structures are then reconfigured as the groups of users change. The first and second hierarchical structures may share one or more proxy servers of the overlaid network of proxy servers.

In a further aspect, the invention provides a method of distributing streaming data in a wide area network having an overlay network of proxy servers that comprises activating the proxy servers to form a hierarchical structure comprising multiple tiers of proxy servers in order to provide a data stream from a corresponding data source to a plurality of users. The proxy servers are activated by predicting a rate of logon of users to the network, and activating a group of proxy servers in one tier as a server farm. Users logging on to the network are distributed to the proxy servers of the proxy farm in a manner so as to balance the data loads of the proxy servers. The hierarchical structure is dynamically reconfigured as users change in order to maintain a predetermined operating condition of the network.

The invention automatically and dynamically adjusts the collaborative proxy network hierarchical structure to account for varying conditions without the need for human operators. This dynamic adjustment may be based on parameters that include end-user population, geographical distribution of user requests, network conditions, and location and capacity of proxy servers, and varying loads. As demand (load) increases, additional proxy servers may be added to the active network and the data connections redistributed. Similarly, the network proxies may use a peering arrangement with other proxies to consolidate live connections when the workload shrinks. A proxy network coordinator (PNC), a logical entity that can be implemented centrally as a single component or in a distributed fashion across multiple components, is used to determine appropriate routes across the proxy network for delivering data streams. In contrast to known approaches that are architected in the network/service layers, the virtual active network of the invention is architected at the application layer. Application level protocols among network proxies are used to support efficient distribution of live data streams.

In addition to ease of deployment, since the routing scheme of the invention is based on application level functions rather than network level functions, a significant advantage of the invention is that it is capable of handling live media broadcasts. It is especially adaptable to deal with the bursty characteristics of multiple user logins (and user logoffs). Furthermore, unlike most other approaches which assume that proxy activation is instantaneous upon request, the invention specifically accounts for the delay involved in proxy activation and connection migration, thereby ensuring no loss of data.

### BRIEF DESCRIPTION OF THE DRAWINGS

FIG. 1, comprising FIGS. 1(a)-(b), illustrates respectively, diagrammatic views showing the architecture of a proxy network in accordance with the invention deployed in a wide area network such as the Internet, and the proxy network arranged as a three-tiered overlaid network;

FIG. 2, comprising FIGS. 2(a)-(d), illustrates a load distribution process in accordance with the invention for distributing expanding loads to proxy servers arranged in a three-tiered hierarchical structure;

FIG. 3, comprising FIGS. 3(a)-(c), illustrates overlays of the same set of cooperating proxy servers to serve multiple sources of data;

FIG. 4, comprising FIGS. 4(a)-(c), illustrate a load consolidation process in accordance with the invention to handle reducing loads;

FIG. 5 illustrates the dynamic allocation of proxy servers for load distribution in a bursty environment;

FIG. 6 illustrates a portion of the internal architecture of a proxy server;

FIG. 7 illustrates a process for initializing a virtual active network;

FIG. 8 illustrates a proxy server process for handling media streams;

FIG. 9 illustrates a process for handling a login event;

FIG. 10 illustrates a process for a logoff event;

FIG. 11 illustrates a module comprising data structures by which a proxy network coordinator maintains information on the dynamic relationships among proxy servers;

FIG. 12 illustrates a DISTRIBUTE process by which a proxy network coordinator distributes loads among proxy servers;

FIG. 13 illustrates a process by which a proxy network coordinator creates a proxy server farm; and

FIG. 14 illustrates a CONSOLIDATE process by which a proxy network coordinator consolidates proxy servers in a decreasing load environment.

### DESCRIPTION OF PREFERRED EMBODIMENTS

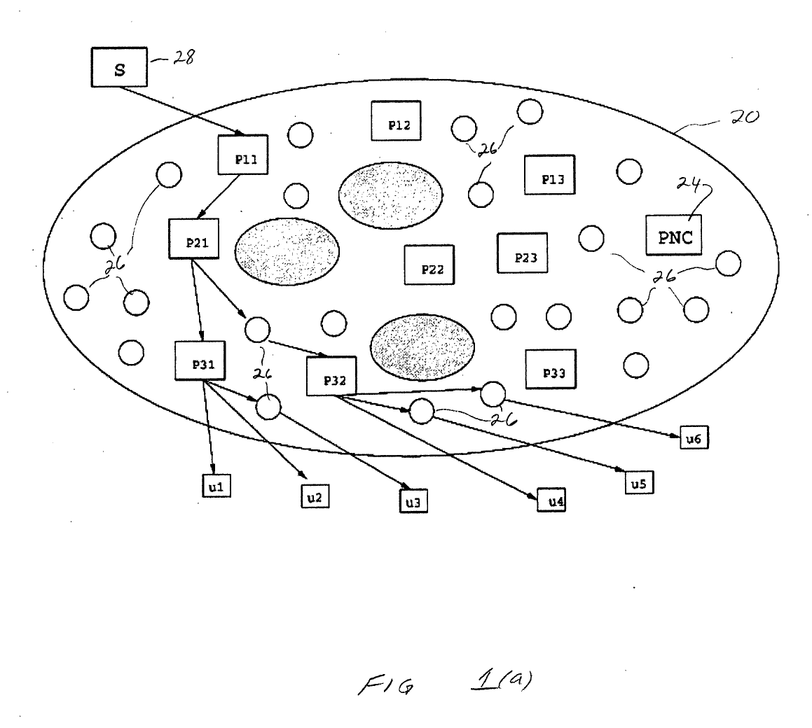

FIG. 1(a) illustrates the architecture of a proxy network in accordance with the invention comprising a plurality of proxy servers P₁₁-P₃₃ deployed in a wide area network 20 such as the Internet. As shown, the proxy network may also include a proxy network coordinator (PNC) 24, and a plurality of network routers 26. During an initialization phase when a media server S is introduced to the network, the proxy network may be partitioned into a hierarchical virtual active network (VAN) structure comprising multiple tiers of proxy servers based on conditions such as the population and distribution of end users u₁-u₆ and the relative distances among the media server, proxy servers and end users, and data loads. This is preferably done by and under the control of the proxy network coordinator (PNC) 24 which coordinates the connections between the proxy servers, as will be described.

FIG. 1(b) shows the proxy network of FIG. 1(a), in which proxy servers P₁₁-P₃₃ are arranged in a three-tiered hierarchical network structure which comprises a single data source, server (S) 28, and proxies P₁₁-P₁₃ arranged in a Tier 1,31; proxies P₂₁-P_{23 arranged in a Tier 2, 32; and proxies P}₃₁-P₃₃ arranged in a Tier 3, 33. Pᵢⱼ indicates the j^{th} proxy server in the i^{th} tier of the overlay network. Proxy servers in a higher tier (lower tier number) of the hierarchical network structure are referred to as “parents”, and servers or users in a lower tier of the hierarchical network structure are referred to as “children”.

The links 30 between components shown in the overlay network are all logical; the actual communication between two proxy servers still requires routing at the level of the network routers 26. End users, uᵢ, may connect to the overlay network proxies via domain name (DNS) resolution based redirection.

In this specification, the term “overlay” refers to a network of proxy servers (“proxies”) deployed strategically on top of an existing network as shown in FIG. 1(a); an “overlay network” refers to the static partitions of the proxies organized in a multi-tier hierarchy structure with respect to a given data stream as shown in FIG. 1(b); and a “virtual active network” refers to the live or active components of an overlay network connected by links such as links 30.

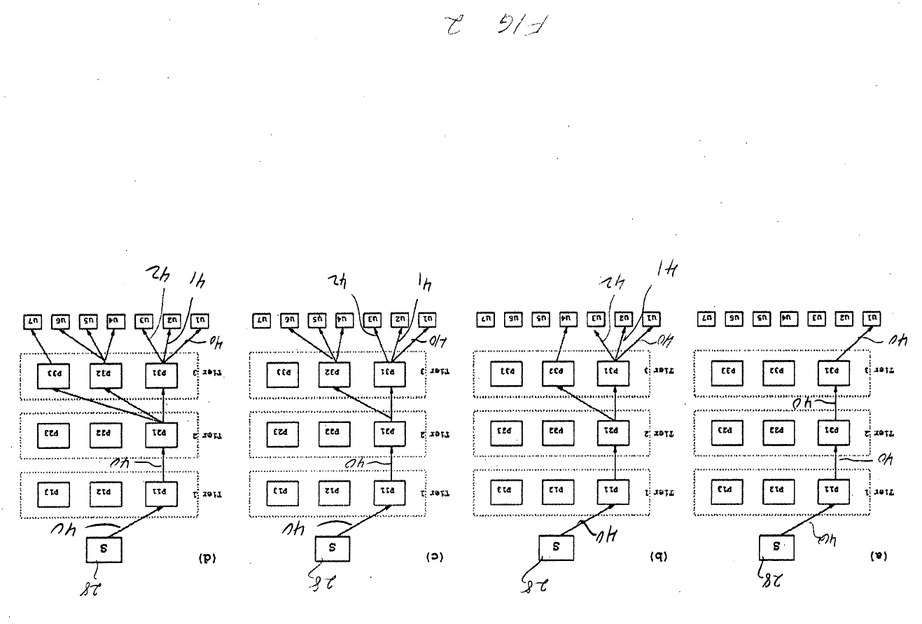

Although FIG. 1 illustrates an overlay network with a single media server S, as with typical network routers, each proxy server 24 can also serve multiple media streams originating from one or more media sources. Also, a single physical proxy server can be shared by multiple VANs, each for a different media source, or for multiple streams from the same source. FIG. 3 shows an example of overlay network architecture consisting of nine proxy servers shared by two media servers, S1 and S2, to deliver streaming data to two different groups of users, i.e., u₁-u₇ and u₈-u₁₄. The solid lines denote the streams from the server S1 and indicate a first VAN, and the dashed lines denote the streams from the server S2 and indicate a second VAN. As shown, many virtual proxies, for example, P₁₁ of the first VAN for data streams from S1 (FIG. 3(b)) and Q₃₁ of the second VAN for data streams from S2 (FIG. 3(c)) share the same physical servers. The virtual active network for each data stream may also have a different number of tiers. As shown in FIGS. 3(b) and 3(c), the numbers of tiers of the virtual active networks for S1 and S2 are three and four, respectively, and the number of proxy servers in each tier may be different.

In the VAN architecture of the invention, redundant retrieval capability is utilized during restructuring of the multicast network. When a proxy needs to change its parent due to varying network conditions, the proxy establishes a connection with the new parent proxy before disconnecting from the old parent proxy. Since the traffic between two proxy servers is more crucial than the traffic between a proxy server and end users (loss of a single inter-proxy connection may affect multiple users adversely), a proxy server may retrieve multiple streams of the same data from the proxy servers in its parent tier. This ensures a higher quality of streaming data delivery.

A proxy server that is serving a stream is an active proxy server (with respect to that particular stream). A proxy server that is active with respect to a given stream may operate in different phases, i.e., an expansion phase, a contraction phase, or an idle phase. When a proxy server is activated by the PNC, it is in the expansion phase until the PNC initiates a contraction phase. During the expansion phase the proxy server continues to accept new connection requests until its load reaches a predetermined threshold, e.g., three data sinks. In response to an active proxy server notifying the PNC that its load has reached a given threshold level, the PNC will perform a consolidation process to redistribute the load, and will activate additional proxy servers in the same tier or a higher tier to serve new or migrated traffic. After such a load distribution operation, a proxy server transitions from the expansion phase to the contraction phase, and will cease receiving new connection requests. Subsequently, when the load of a proxy server drops below a given threshold, the proxy server requests consolidation from the PNC. When the load falls to zero with respect to a given data stream, the server becomes idle.

The proxy network coordinator (PNC) is a logical entity that can be implemented centrally as a single computer 24 (as shown in the figures) or in a distributed fashion across multiple network components. The PNC coordinates the connections between proxy servers using load distribution and load consolidation processes as will be described shortly. For each streaming data server S1, S2, the information the PNC maintains in order to establish and dynamically manage the VANs may include, for example, the numbers of tiers and proxy servers in each tier; the network status between proxy server pairs in adjacent tiers; a list of active proxy servers in each tier; and the hierarchical structure of the virtual active network as identified by proxy server pairs in adjacent tiers.

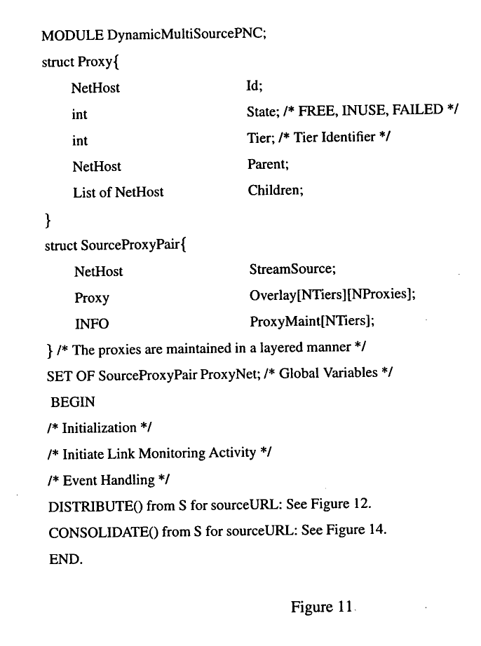

A principal task of the PNC of the invention is to maintain the hierarchy structure of the VAN for each media server. It does this by dynamically allocating and reallocating resources in response to messages from the proxy servers to adapt to changing network conditions, loads and events. During an initialization phase, the static overlay network of proxy servers may be initialized by a PNC associated with a media source into a VAN by activating one proxy server at each tier in preparation to forming a connection path across the overlay network for the media stream. The PNC may also activate multiple proxy servers in response to actual or anticipated network conditions. The actual establishment of parent-child relationships among the proxies occurs during dynamic restructuring of the virtual active network by DISTRIBUTE and CONSOLIDATE processes, as will be described. An active proxy server initiates a DISTRIBUTE process by sending a DISTRIBUTE message to the PNC when its load reaches a selectable maximum threshold. In response the PNC activates one or more proxies in the same tier. Similarly, a proxy server initiates a CONSOLIDATE process by sending a CONSOLIDATE message to the PNC when its load falls below a selectable minimum threshold. This message indicates to the PNC that the proxy should be made idle or dormant. A sequence of DISTRIBUTE and CONSOLIDATE processes causes the proxy hierarchy structure of the VAN to expand and contract dynamically to meet changing conditions. These PNC processes will be described in detail in connection with FIGS. 12-14.

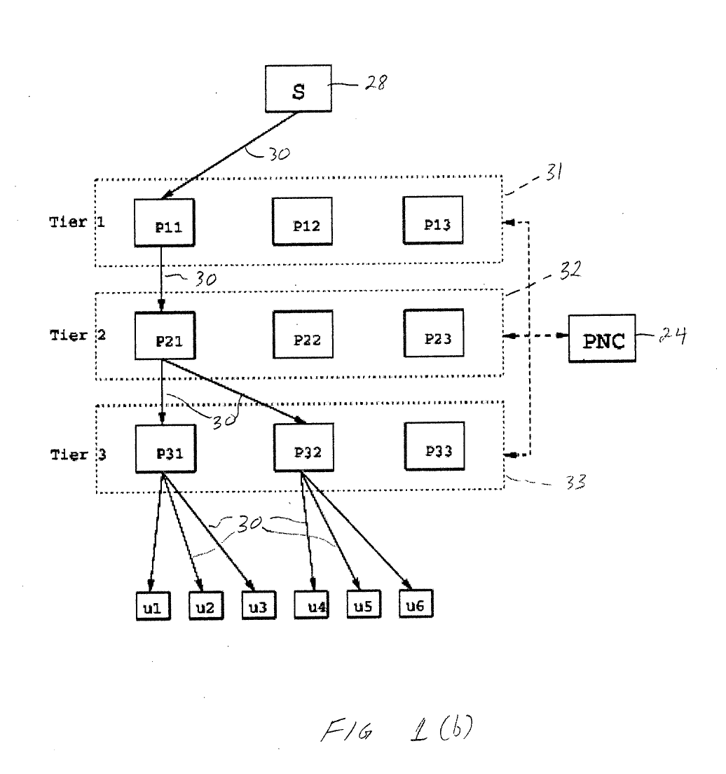

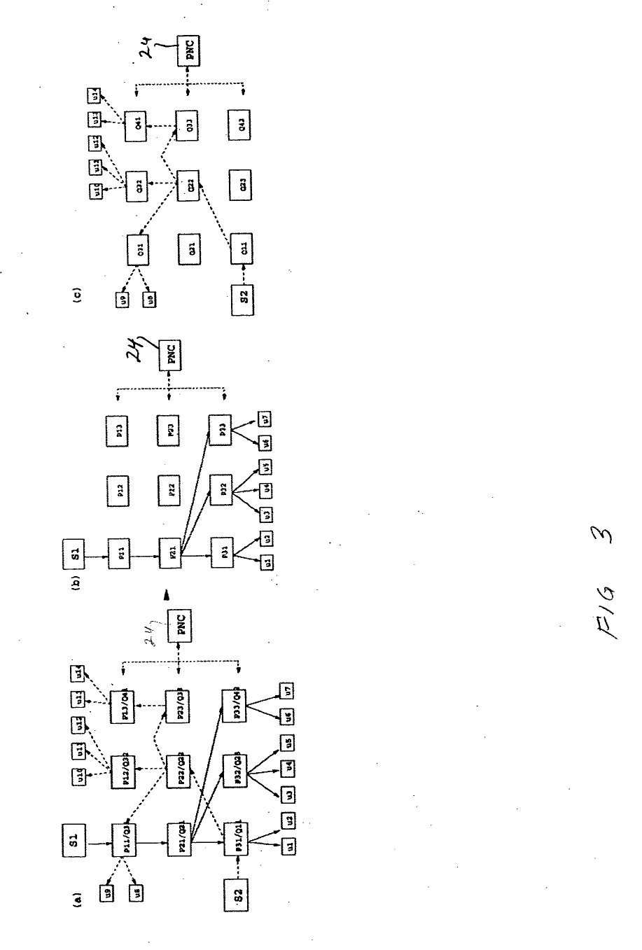

The PNC may activate the minimum number of proxies required at each tier to ensure coverage of all anticipated endusers for a given media event. The IP addresses of proxies to which the endusers should be redirected when they request for the media stream is registered using the well-known Domain Name Service, DNS, system. The IP address of each end user is maintained in the proxy servers while the proxy network hierarchical information is maintained only at the PNC. When the number of enduser logon requests to a proxy server increases to the predetermined maximum connection threshold, the proxy server may send a DISTRIBUTE request message to the PNC to expand the VAN hierarchy by adding additional proxies. The number of proxies activated in response is preferably based on the rate at which endusers arrive onto the network (which can be determined as will be described below). Similarly, when endusers logoff and the connections to a proxy server decrease to a minimum connection threshold, the server may send a CONSOLIDATE request message to the PNC. In response, the PNC contracts the VAN hierarchy to redistribute connections and minimize bandwidth usage. Due to the hierarchical structure of the VAN, most of the changes tend to occur in the lower tiers of the overlay network. The number of changes decreases significantly in the upper tiers in the overlay. This advantageously results in a media server being cushioned from the adverse effects of abrupt changes in the network structure and loading. FIGS. 2 and 4 illustrate the manner in which the VAN structure expands and contracts.

FIGS. 2(a) through (d) show an example of a load distribution process for expanding a VAN. In this example shown, there is a single source server (S) 28 for the media source data. Below the source server there are the three Tier 1 proxy servers P₁₁, P₁₂, and P₁₃. Below the Tier 1 proxy servers in the structural hierarchy, there are Tier 2 proxy servers P₂₁, P₂₂, and P₂₃. At the lowest Tier 3 there are proxy servers, P₃₁, P₃₂, and P₃₃. Below Tier 3 are the end users u₁-u₇. For purposes of the following explanation, the load capability of each proxy server may be assumed to be limited to three simultaneous connections.

At a first time, represented by FIG. 2(a), when user u₁ wishes access, it is directed by the DNS mechanism to send a request to P₃₁. The PNC causes one proxy (P₁₁, P₂₁, and P₃₁) at each of Tiers 1-3 to be activated to form a streaming path 40 between the media source server 28 and user up. As users u₂ and u₃ request access, streaming paths 41 and 42 are provided by P₃₁, as shown in FIG. 2(b). When user u₃ arrives, however, P₃₁ reaches a maximum threshold corresponding to the limit of its assumed capacity (in this example) and it sends a DISTRIBUTE request to the PNC (not shown in FIG. 2). In response, the PNC may select P₃₂ from the overlay network and activate it by sending a message to P₃₂ to indicate that it has been activated as part of the VAN and that its parent server is P₂₁. PNC then updates the DNS resolution mechanisms so that later users u₄-u₆ are directed to P₃₂ instead of P₃₁ (FIG. 2(c)). The arrival of u₆ brings the connections to P₃₂ to its threshold of three (assumed in the example), and will trigger a DISTRIBUTE request by P₃₂ to activate a new proxy. The arrival of u₇ (FIG. 2(d)) will similarly trigger a DISTRIBUTE request by P₂₁, which now is at its assumed capacity, to activate a new proxy in Tier 2. This sequence of events illustrates the process by which the virtual active network of the invention expands gracefully as the network load increases.

FIGS. 4 (a)-(c) show an example of load redistribution in a contracting VAN. As the number of users in the network drops due to log offs, the VAN structure has to contract by deactivating proxy servers so that the proxies and the network resources are not underutilized and the network bandwidth is optimized. This load redistribution process is referred to as CONSOLIDATION, and is also controlled by the PNC.

FIG. 4(a) shows a hypothetical configuration of the VAN (corresponding to that shown in FIG. 2(d)) with active proxies P₁₁, P₂₁, P₃₁-P₃₃ and users u₁-u₇. When users u₄, u₂, and u₃ log off one after another (FIG. 4(b)), the reduction in the load at P₃₁ triggers a CONSOLIDATE request from P₃₁ to the PNC (not shown). In response, the PNC executes a CONSOLIDATE process (as will be described below) by sending a message to the children of P₃₁ (u₁ in this case) to switch to another proxy server. Preferably, the switch is to the most recently activated proxy server, i.e., P₃₃. Consequently, u₁ logs off from P₃₁ and logs on to P₃₃, which results in P₃₁ logging off from P₂₁ (FIG. 4(c)).

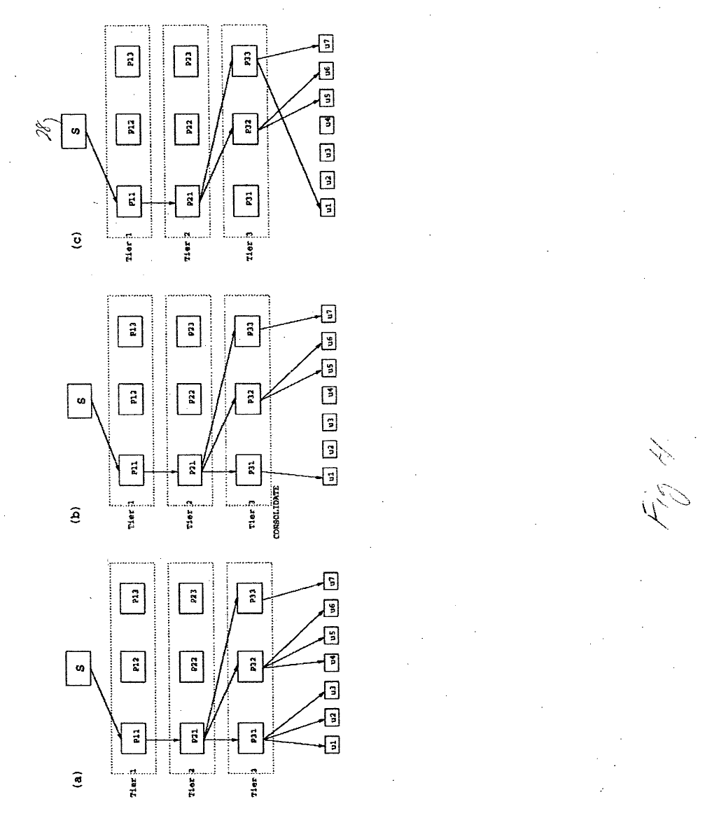

Allocating proxy servers one at a time to expand a VAN as described in connection with FIG. 2 may not be acceptable when traffic is bursty and rapidly changing, such as, for example, at the beginning of a media event when most of the users login to the network. To deal with the need for fast restructuring, the PNC may tune the allocation rate of new proxy servers to deal with anticipated loads and bursty traffic. This may be done by estimating the rate of arrival of users, the capacity of the servers to handle loads, and the rate at which new servers will be required to be activated to provide the needed capacity to handle the anticipated load. An preferred example of a tuning process is illustrated in FIG. 5, and will now be described.

When the PNC receives a DISTRIBUTE message from a proxy server, the PNC may compute the rate of arrival of new users as:

$$New \backslash \_ User \backslash \_ Arrival \backslash \_ Rate = \frac{Number\_of \_Proxies \_assigned}{current\_time \text{-} Last\_DISTRIBUTE \_request \_time} .$$

PNC next computes the new average user arrival rate as:

(New\_User\_Arrival\_Rate+α×Average\_User\_Arrival \_Rate).

The value of the parameter a may be selected to provide a desired tuning, and its value may be fixed or dynamically changed according to network conditions. A value of 1 for α treats all access patterns equally, while a value of 0 considers only the current user arrival pattern. The PNC then computes the number of proxy servers needed to be activated for the new user arrival rate as follows:

$$Number \backslash \_ of \backslash \_ Proxies \backslash \_ assigned = Round ( Number \backslash \_ of \backslash \_ Proxies \backslash \_ assigned \times \frac{Average\_User \_Arrival \_Rate}{Old\_Average \_User \_Arrival \_Rate} ) .$$

When more than one proxy server is activated at the same time, the group of proxy servers functions like a server farm. The PNC may then distribute the connection requests from end users and proxy servers to the group of activated proxy servers in the server farm in a way to balance their loads, such as in a “round-robin” fashion. As soon as any one of the proxy servers in this server farm group sends a DISTRIBUTE request to the PNC, the PNC treats this request as a collective distribute request from all of the servers. The rationale for this is that if the requests are distributed to all activated proxies in a round-robin fashion, then all proxy servers will be equally loaded. The arrival rate formulation may therefore be adjusted to handle simultaneous arrivals of multiple DISTRIBUTE requests. Furthermore, the PNC may deactivate all the proxies that were activated at the same time to minimize the generation of redundant DISTRIBUTE events.

The server farm approach is in contrast to distribution to a single server. When a single proxy server is serving live streams from multiple media servers, the DISTRIBUTE events are preferably treated independently. That is, a DISTRIBUTE request by a proxy server on behalf of a media source does not impact the state of other media sources at that proxy server. In order to achieve this independence, the load control parameters may be dynamically adjusted when a media source handling is included or by the proxy server.

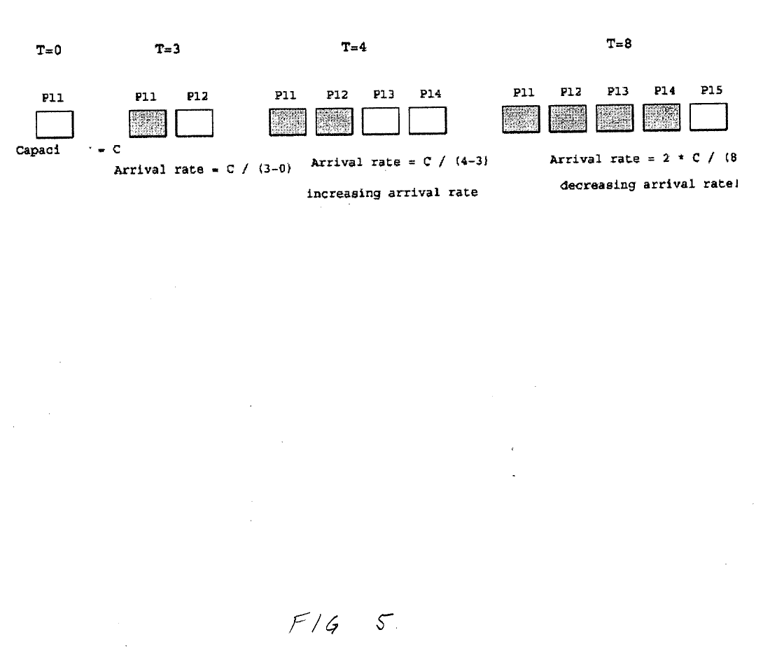

FIG. 6 illustrates a portion of the relevant logical architecture of a typical proxy server 100, such as P23. The proxy server may physically comprise a computer. A main resource of the proxy server is a buffer memory 110 used for storing the streaming media. The buffer is preferably shared and accessed by an incoming stream handling module (ISHM) 120 and an outgoing stream handling module (OSHM) 130. ISHM 120 interfaces to a media server or to parent proxy servers in the tier immediately above the proxy server 100 in the overlay network, and it receives media streams from the media server or from parent proxy servers. ISHM is responsible for managing connections, disconnections and reconnections to the parent proxy servers, as specified by the PNC. Preferably, it has the capability of connecting to multiple parents for access to multiple sources of a given data stream to enable redundant and, therefore, robust, media delivery. As shown in the example of FIG. 6, proxy server 100 (P23) may connect to three parent proxies P11, P12 and P14. ISHM may fetch media streams from P11, P12 and P14 block-by-block, and store the blocks in the buffer memory 110 as, for example, in block order as shown. ISHM may eliminate redundant blocks received from its parent proxies, such as one of Blocks 23 from P11, P12 and P14, and one of Blocks 22 from P12 and P14, by checking either or both of the block sequence numbers or time stamps. After eliminating redundant blocks, a retained block is stored in the buffer memory 110.

OSHM 130 interfaces to the buffer memory as well as to child data sinks, such as users u₁-u₅, and proxies P31-P33, in the tier immediately below proxy server 100. The OSHM provides streaming media data to the users and down-stream child proxies.

Proxy server 100 also keeps track of the end users and child proxy servers in the next lower tier that are retrieving the streaming media through connections to the proxy server 100. This may be done by tracking the IP addresses of the end users and down-stream proxy servers who request data streams from proxy server 100. These IP addresses may be extracted from the media protocol, such as the RTSP, headers. When redirection of end users and proxy servers in the lower tier is needed, proxy server 100 may send out redirection messages to its connected end users to switch to a newly assigned proxy server, while the proxy server coordinator (PNC) sends messages to redirect the child proxy servers in the lower tier to the new parent proxy server. Accordingly, proxy server 100 may maintain the IP address of each connected end user, while the PNC maintains proxy network hierarchical structure information. Moreover, since the VAN architecture permits redundant retrieval of streaming media during the restructuring of a multicast network, when proxy server 100 needs to change its connection to a new parent due to changing network conditions, it first establishes a connection with the new parent before disconnecting from the old parent proxy server. Additionally, as described above in connection with FIG. 3(a), one proxy server may be shared by multiple VANs for handling different media sources, or for handling multiple streams from the same source. Therefore, the proxy server also maintains other information related to its sink and source connections and the network, as indicated in FIG. 6.

Referring to FIG. 6, Stream ID designates a unique identification, e.g., a URL, for each media stream handled by the proxy server. As shown in the example, proxy server 100 may handle media streams from two different sources at URLs “www.ccr1.com” and “www.nec.com”. Proxy server 100 may also handle three different media streams, i.e., “demo1.rem”, “demo 2.rem” and “demo3.rem” from source www.ccr1.com. For delivering the three different media streams, only a single virtual active network tiering assignment is necessary. All proxy servers in a particular VAN will have the same prefix, e.g., P, for source www.ccr1.com. On the other hand, a separate virtual active network tiering assignment, and proxy prefix such as Q, will be required for handling media from source www.nec.com. Furthermore, although media streams demo1.rem, demo2.rem and demo3.rem may be delivered through the same VAN, the proxy server assignment in each tier may be different. If the geographical distribution of end users for the three media streams is a wide one, it may be beneficial to employ different virtual active network tiering assignments for the servers. While proxy servers may be logically partitioned into multiple virtual hosts, as shown in FIG. 6, the number of simultaneous connections and the bandwidth constraints of the server needs to be enforced on a machine-wide basis.

As shown in FIG. 6, proxy server 100 may also maintain information related to the hierarchical structure of the proxy network such as the IP addresses of upstream and downstream proxy servers, users and the PNCs. FIG. 6 shows, for example, that proxy server 100 maintains information on “Disconnecting parents: P11” (P11 is disconnecting as indicated by the dotted line between P11 and the ISHM); “Connecting parents: P12 ”; “Connected parents: P14”; the IP addresses of the end users which are logged in at the proxy server, as well as children and forwarding proxy servers. Other information may include the physical capacity corresponding to the number of downstreams that the server can support and its logical capacity corresponding to the maximum number of downstreams assigned to the proxy server.

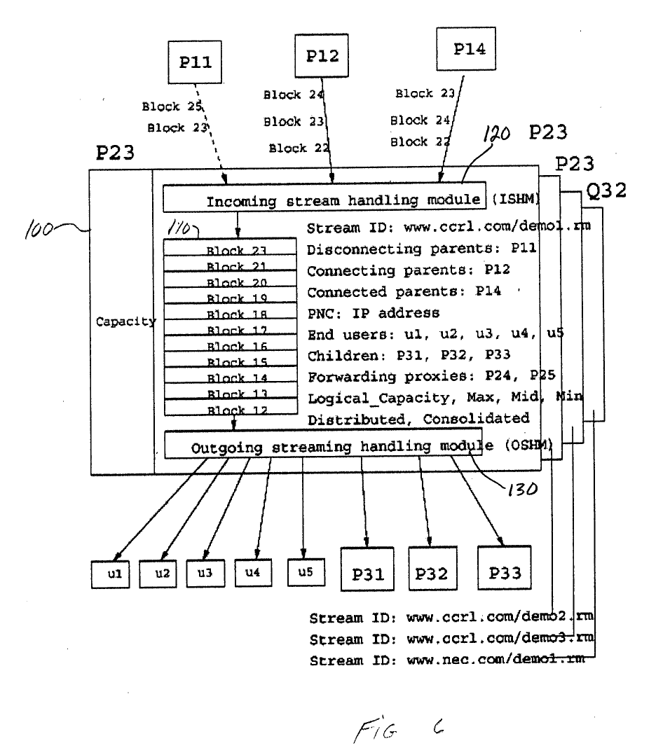

As previously noted, the PNC determines the hierarchical structure of a VAN by the allocation of individual proxy servers into tiers within that structure. It is desirable that this structure and the allocation of proxy servers be such that the utilization of data network resources, e.g., bandwidth, be optimized for efficiency and data integrity. A preferred approach to accomplishing this is to partition the data network into geographical regions and to assign proxy servers and the tiering structure in each region to users located in that region, for example, by directing ISPs to servers in their region, upon initialization of a VAN. This may be accomplished by determining the proxy servers in each region, and the layers (tiers) to service the users in the region. This approach is illustrated in FIG. 7.

As shown in FIG. 7, proxy servers 201-204 in a first region (Region1) may be activated in a four-tier hierarchical structure to provide media data from a media server S to users u₁-u₄ located in region R1. Similarly, proxy servers 301-303 may be allocated to a second region R2 to serve users u₅-u₈ located in that region, and proxy servers 401-404 may be allocated to a region R3 to serve users u₉-u₁₁ in region R3. Using the media server S as the media source and the center of a fanout, the overlay structure of the VAN for that particular media source may be determined based upon the number of the autonomous data systems or ISPs in each region, the connectivity information among the data servers and the size of each for each region. This task may be performed during run time and adjusted by region and layer partitions based upon network conditions. The PNC may then affect the overlay network structure by sending the appropriate URLs to the various proxy servers to identify parent and child proxy servers.

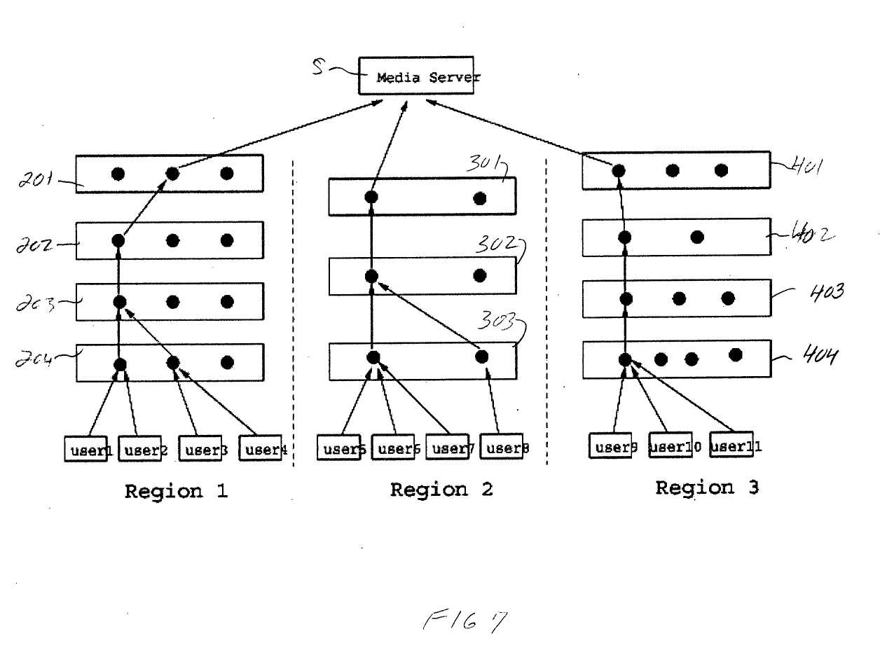

FIG. 8 illustrates a proxy server module referred to as “DynamicMultiSourceProxyServer” that provides data structures for maintaining connection states of multiple media streams and message-based APIs for communicating with other proxies and the PNC. As shown, the module may comprise two data structures for maintaining information on the connection states of the multiple data streams and on the current parent proxies to which a server must connect for each stream source.

The first data structure “ConnectionState” shown in FIG. 8 maintains the current state of all live connections that are passing through a given proxy. This includes the URL of the stream source for which the connection is maintained, the IP address and other connection related information of the parent to which the proxy is connected, and the IP addresses of all the child hosts (either another proxy or an end-user) that are being served by the proxy server. The PNC may offload the task of end-user maintenance to the proxy server itself. The second data structure “ProxyParent” shown in FIG. 8 maintains information on the current parent proxy to which the proxy server must connect for each stream source.

Two main events that a proxy server must support are LOGIN and LOGOFF requests from users. Depending upon the active network structure, a user may be another proxy server, e.g., a child proxy, or an enduser. Other processes shown may be used to maintain the virtual active network for each stream source. A process “SwitchToParent” may be triggered by the PNC if the PNC detects that there are network problems or if the proxy load needs to be balanced. Similarly, another process, MONITOR, may be initiated by the PNC so that the proxy can monitor network links between consecutive tiers in a distributed manner. The PNC may require, for example, that for each stream source a proxy server in tier k+1 monitor all the parent proxies in tier k.

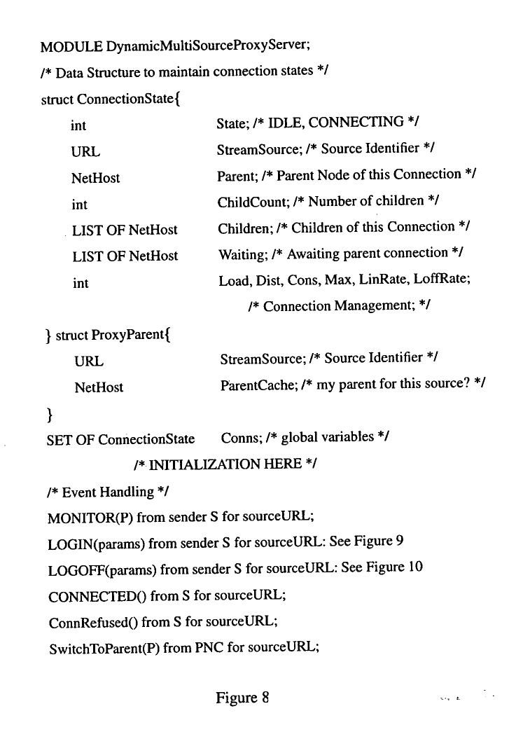

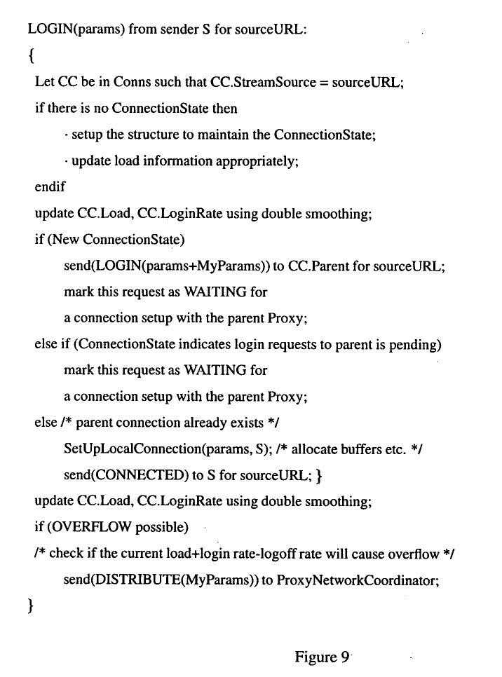

FIGS. 9 and 10 illustrate, respectively, the LOGIN and LOGOFF processes which are performed by proxy servers in response to login and logoff events. The LOGIN process (FIG. 9) may be triggered either by another proxy or by an end-user. If the event is triggered by a proxy, this means that the proxy has been assigned to be a parent proxy for the specified media stream. As shown in FIGS. 8 and 9, upon receiving a LOGIN request from a sender S for a sourceURL, a check is made to determine if the connection is already active for the specified sourceURL. If not, the connection is initiated by setting up a local data structure and uploading the sender's request for a connection to the parent proxy. Also, if a new media begins to share the proxy server, the server dynamically adjusts the load control parameters to account for the fact that there is more contention for physical resources at the proxy. If the connection is already active then the LOGIN request is served locally by including the request sender S in the local connection state. If the server's load exceeds a predetermined maximum threshold, the server sends a DISTRIBUTE request to the PNC for additional proxies to be activated in its tier. The load condition for the DISTRIBUTE event may be determined by the login rate and the logoff rate. If the two rates are such that in a next predetermined time period, ΔT seconds, the proxy may reach its maximum capacity, the proxy triggers a DISTRIBUTE request to the proxy network coordinator. The parameter ΔT may be set to afford sufficient time for the PNC to activate new proxy servers to minimize loss of data.

The LOGOFF process shown in FIG. 10 is analogous to the LOGIN process just described. When a sender S triggers this event at a proxy, the proxy removes S from the connection state and updates the data structures of FIG. 8. If S is the last child to request logoff, the proxy sends a LOGOFF message to its parent server since it no longer needs a connection. If the workload falls below a certain threshold due to multiple logoff events, the proxy server notifies the PNC that it should be made dormant and move to an idle state by a sending a CONSOLIDATE message. On receiving the message, the PNC deactivates the proxy by moving its connections to another active proxy server in the same tier. If that proxy server is the only remaining proxy server serving the content stream in the same tier, the PNC will ignore the CONSOLIDATE message.

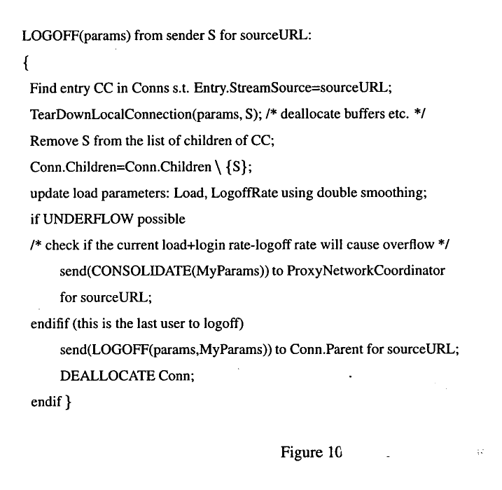

FIGS. 11-14 illustrate the data structures and processes which may be employed in the proxy network coordinator for maintaining the application level proxy network for multiple media streams from different sources. FIG. 11 illustrates a module designated as “DynamicMultiSourcePNC”, which includes data structures for maintaining static network information and the dynamic relationships among the proxies. A message-based API may be used by the proxy servers to coordinate their activities. A data structure SourceProxyPair maintains information on the relationship between stream sources and the corresponding proxy servers.

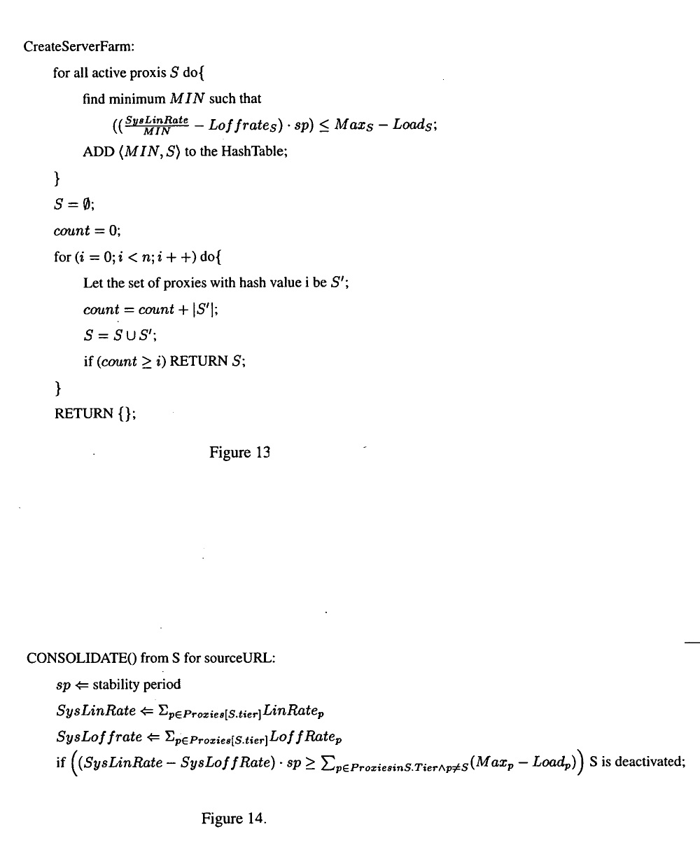

The DISTRIBUTE process is illustrated in FIG. 12 and the CONSOLIDATE process is illustrated in FIG. 14, and these will be described shortly. First, however, more description of the dynamic adaptive resource allocation afforded by the invention will be described.

In networks of the type with which the invention may be employed, user traffic may ordinarily be directed to an arbitrary set of servers. There is an associated time delay in redirecting the traffic between the servers due to the time required to set routers and load the media. This time delay for the redirection process may be designated as ΔT. Additionally, in order to afford network stability, it is undesirable to remove a server from the network if it will be needed a short time later. A stability parameter “sp” may be used as described in more detail below to control stability of the network. When a server is added or removed, the invention attempts to ensure that during the next period sp there will not be a need to change the number of servers in the network. Also, when a server expects that during the next time ΔT its load will exceed its capacity, it may send a DISTRIBUTE request to the PNC. The parameter ΔT is preferably selected to provide sufficient advance warning to the PNC so that it may redirect users to an available server before some users are rejected due to an overload.

FIG. 12 illustrates the DISTRIBUTE process. When the PNC receives a DISTRIBUTE request from a proxy, it first checks whether during the next sp time the capacity available in the network will be sufficient to serve the users that request the particular media stream. If not, it adds the minimum number, m, of servers that will be necessary to handle the load during the sp period. If the PNC is unable to activate the anticipated number server needed, it may activate as many servers as it can, and group them into a server farm as previously described.

If the PNC expects that the overall server capacity will be sufficient for the next sp period, the PNC may try to find a suitable proxy or group of proxies to which it can redirect traffic to optimize the network. By re-grouping the existing servers, the PNC may overcome the restrictions due to fragmentation by re-grouping the proxies so each proxy will have sufficient capacity to handle new users during the next ΔT period. It may do this by estimating whether servers have the capacity to handle the expected loads in the following manner.

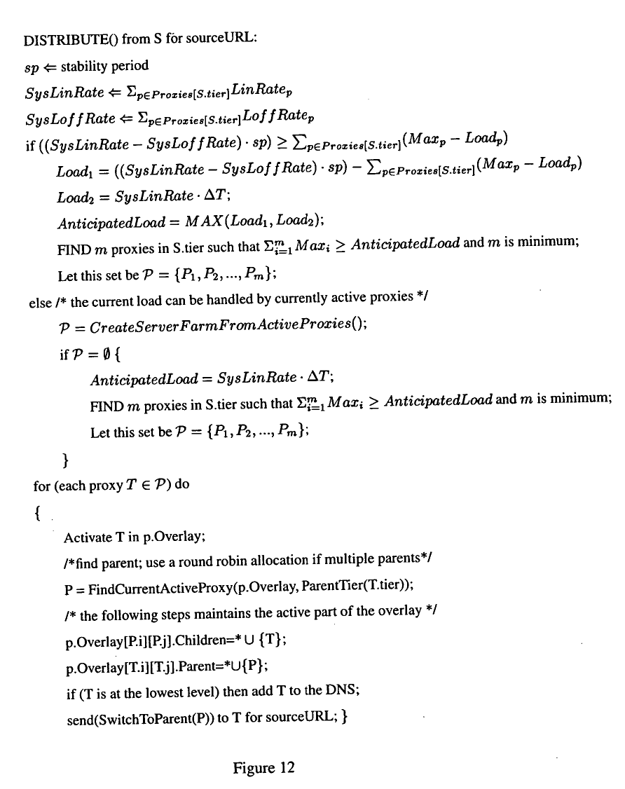

In FIG. 12, “SysLinRate” denotes the average predicted login rate and “Loffrateₛ” denotes the average predicted logoff rate for each proxy server S. Each server in a group of m servers will observe SysLinRate/m logins. If a proxy can handle the load assigned to it, then either the logoffs are higher than logins ((SysLinRate/m)<Loffrateₛ) or it has available space for ΔT period (Δt*((SysLinRate/m)−Loffrateₛ)<Maxₛ−Loadₛ). Therefore, for any given proxy S, the minimum m (MINₛ) for this condition can be easily calculated. After calculating these MINₛ values, each proxy can be hashed according to those values. An eligible group of size l exists if the number of the proxies that has MINₛ value less than or equal to l is greater than or equal to l. Since any suitable minimum size group is acceptable, the first l servers may be chosen. Min l and MINₛ values can be evaluated for the worst case based upon the number of active proxies. The procedure used to create a server farm group is shown in FIG. 13.

FIG. 14 illustrates the PNC CONSOLIDATE process to redistribute the load and idle proxies when the network load decreases. When a proxy expects to reach to zero load level in a short time, as determined by the login and logoff rates, the stability parameter sp, and the loads, it may send a CONSOLIDATE request to the PNC. The sp parameter may be adjusted to achieve a desired rate of consolidation. In any case, a proxy must be in a contracting mode, i.e. log-offs must be higher than logins, to send a CONSOLIDATE request.

When the PNC receives the CONSOLIDATE request, it checks whether the consolidation of this server will necessitate the creation of a new server in the next sp time period. It also checks whether there is enough space in the currently active proxies to handle additional traffic after consolidation. If both of the conditions are satisfied then the proxy is consolidated. Otherwise, the request is ignored.

As mentioned above, the adaptive resource allocation methods of the invention depend on predicting the expected number of users in a predetermined time period. Preferably, the time period is selected to afford good predictability. The invention does not try to predict very far in advance, and a simple time-series prediction method such as double exponential smoothing has been found effective in predicting login and logoff rates. Double exponential smoothing is used also because it is easy to implement and it is very efficient to execute. Double exponential smoothing use the following two equations to predict the future values.

Sₜ=αyₜ+(1−α)(Sₜ₋₁+Bₜ₋₁) (1)

bₜ=β(Sₜ−Sₜ₋₁)+(1−62 )bₜ₋₁ (2)

where yₜ is the last value observed and 0<α,β<1. Suitable values are α=0.9 and β=0.1. Sₜ is the value of the average future prediction.

The parameters of the double exponential smoothing are preferably updated every Δt/10 period, based on the number of logins in the last Δt10 period. For example, if Δt is 10000 milliseconds (ms) and 300 users logged in in the last second, the last login value observed will be (yₜ) (300/1000) per ms. The new Sₜ value calculated will be used as the prediction of average number of users login per ms. To predict the values for at least Δt time in the future, it may be desirable to update the predictions more often then Δt to capture any sudden changes in user pattern. However, it should not be updated so frequently as to create a bottleneck. The choice of Δt/10 period results from these considerations.

As discussed earlier, a proxy in a child tier monitors the network connectivity to all the proxies in the parent tier based on the static overlay structure. If the network connectivity from child proxy S to a parent proxy P is lost, S sends a LinkDowngrade event to the PNC. In this case, PNC first tries to find an alternate parent proxy P′ for S′ and sends a message SwitchToParent to S asking it to establish P′ as the new parent. If an active parent other than P does not exist in that case a sibling proxy S′ is located and the children of S are migrated to S′. If both P′ and S′ are non-existent then in that case PNC activates a proxy P″ in the parent tier (similar to DISTRIBUTE) and asks S to switch to P″. In addition to monitoring the network links, the PNC may monitor the network host status of each proxy in the system. If the PNC detects that a proxy server has crashed (through a timeout mechanism, not shown), then the PNC may migrate all the children of failed proxy with respect to each media type to an alternate active proxy in the same tier. If no active proxy exists, then a proxy is activated in the specified tier. Through the above message-based events, the PNC dynamically maintains the structure of the virtual active network.

The foregoing has described preferred embodiments for a peer-to-peer virtual active network (VAN) network architecture for streaming data delivery in which a plurality of proxy servers in a hierarchical structure are coordinated to deliver media streams. The hierarchical structure is dynamically reconfigured based on network conditions, such as to optimize (e.g., minimize) bandwidth and improve network performance. It will be appreciated that changes in these embodiments may be made without departing from the spirit and principles of the invention, the scope of which is defined in the claims.

1. A method of distributing streaming data in a wide area network having an overlay network of proxy servers comprising activating proxy servers to form a hierarchical structure comprising multiple tiers of proxy servers with respect to a data stream to distribute said data stream from a data source to a plurality of users, said proxy servers being activated in said tiers based upon the users and to provide a predetermined network operating condition; and dynamically reconfiguring said hierarchical structure of proxy servers as users change to maintain said predetermined network operating condition.

2. The method of claim 1 further comprising activating proxy servers to form another hierarchical structure comprising multiple tiers of proxy servers with respect to another data stream from another data source, at least one or more of the proxy servers of said other hierarchical structure forming part of the first-mentioned hierarchical structure.

3. The method of claim 2, wherein said other hierarchical structure is formed to provide said predetermined network operating condition.

4. The method of claim 1, wherein said predetermined network operating condition comprises minimum network bandwidth to provide said data stream to said users.

5. The method of claim 1, wherein said users are distributed with respect to the proxy servers of said overlay network, and said activating comprises activating proxy servers based upon the distribution of said users.

6. The method of claim 5, wherein said activating comprises activating proxy servers to reduce lengths of data paths between said proxy servers and said users.

7. The method of claim 1, wherein said dynamic reconfiguring comprises activating additional proxy servers in said tiers as users logon.

8. The method of claim 1, wherein said dynamic reconfiguring comprises consolidating proxy servers to contract said hierarchical structure as users logoff.

9. The method of claim 1, wherein said activating comprises predicting a rate at which users are expected to logon, and activating a new proxy server to handle an anticipated data load.

10. The method of claim 9, wherein said activating comprises activating said new proxy server when data path connections to one of said first-mentioned proxy servers reaches a predetermined threshold.

11. The method of claim 1, wherein said dynamic reconfiguring comprises deactivating a proxy server when data connections to such proxy server drop to a predetermined threshold.

12. The method of claim 1, wherein said activating comprises activating a plurality of proxy servers in a tier as a server farm, and allocating data connections to the proxy servers of said server farm so as to balance loads on such proxy servers.

13. The method of claim 1, wherein said activating and reconfiguring are performed by a proxy network coordinator.

14. The method of claim 13, wherein said proxy network coordinator redistributes data loads on a proxy server in response to receiving a distribute message requesting redistribution of data loads from such proxy server upon the data loads reaching a predetermined threshold.

15. The method of claim 13, wherein said proxy network coordinator consolidates data loads on proxy servers upon receiving a message requesting consolidation of data loads from one of such proxy servers upon said data loads dropping to a predetermined threshold.

16. A method of distributing streaming data in a wide area network having an overlay network of proxy servers comprising activating proxy servers of the overlay network to form a first hierarchical structure of proxy servers in multiple tiers to distribute a first data stream from a first data source to a first group of users; activating proxy servers of the overlay network to form a second hierarchical structure of proxy servers in multiple tiers to distribute a second data stream from a second data source to a second group of users; said first and second hierarchical structures sharing one or more proxy servers, and the numbers of tiers and proxy servers in each tier of said first and second hierarchical structures being based upon the users of said first and second groups; and dynamically reconfiguring said first and second hierarchical structures as said first and second groups of users change.

17. The method of claim 16, wherein said dynamically reconfiguring comprises activating an additional proxy server in a tier of the hierarchical structure and distributing data loads to said additional proxy server upon data loads at a proxy server of such tier reaching a predetermined threshold.

18. The method of claim 16, wherein said dynamically reconfiguring comprises deactivating a proxy server in a tier upon data loads to such data server dropping to a predetermined threshold, and consolidating such data loads at other proxy servers at such tier.

19. The method of claim 16, wherein said activating steps comprise activating proxy servers in said hierarchical structures to provide a predetermined network operating condition.

20. The method of claim 19, wherein said activating comprises activating proxy servers to optimize network bandwidth in supplying said steaming data to users.

21. The method of claim 16, wherein said dynamically reconfiguring comprises regrouping proxy servers in said first and second groups such that each group of proxy servers will have capacity to handle anticipated users during a predetermined time period.

22. The method of claim 21, wherein said regrouping comprises predicting expected login and logoff rates of users to determine anticipated data loads during said predetermined time period.

23. The method of claim 22, wherein said predicting comprises predicting using a double exponential prediction method.

24. The method of claim 16, wherein said activating of proxy servers to form said first hierarchical structure comprises activating a group of proxy servers at a tier to form a server farm to handle bursty network conditions.

25. The method of claim 24, wherein connections to said first data stream are allocated to proxy servers of said server farm so as to balance data stream connections to such servers.

26. A method of distributing streaming data in a wide area network having an overlay network of proxy servers comprising predicting a rate of logon of users for access to a data stream from a data source; activating proxy servers to form a hierarchical structure comprising multiple tiers of proxy servers with respect to the data stream, said activating comprising activating a plurality of proxy servers in a tier as a server farm; and distributing users logging on to the proxy servers of said server farm so as to balance data loads of such proxy servers; and dynamically reconfiguring said hierarchical structure of proxy servers as users change.

27. The method of claim 26, wherein said distributing users comprises distributing users to proxy servers of said server farm in a round-robin manner.

28. The method of claim 26, wherein said dynamically reconfiguring said hierarchical structure comprises automatically reconfiguring said hierarchical structure as users change to maintain a predetermined network operating condition.

29. The method of claim 28, wherein said automatically reconfiguring comprises automatically reconfiguring the hierarchical structure to minimize network bandwidth to provide said data stream to said users.

30. The method of claim 26, wherein said dynamically reconfiguring comprises deactivating one or more proxy servers and consolidating data loads at an active proxy server as users log off.

31. The method of claim 30 further comprising consolidating a data load from a proxy server being deactivated by forming a redundant data path to said active proxy server before deactivation of such proxy server being deactivated.

32. The method of claim 31, wherein each proxy server receives data in blocks, said redundant data path providing one or more blocks of redundant data, and wherein the method comprises discarding redundant blocks of data at said active proxy server.

33. The method of claim 26, wherein said activating and reconfiguring are performed by a proxy network coordinator.

34. The method of claim 33, wherein said proxy network coordinator comprises a centralized server.

35. The method of claim 33, wherein said proxy network coordinator comprises a distributed server.

36. The method of claim 33 further comprising receiving a distribute message from a proxy server requesting distribution of data loads to such proxy server when such data loads reach a predetermined threshold.

37. The method of claim 36, wherein said proxy network coordinator receives said distribute message and reconfigures said hierarchical structure to distribute said data loads.

38. The method of claim 33 further comprising receiving a consolidate message from a proxy server requesting consolidation of data loads upon data loads to such proxy server dropping to a predetermined threshold.

39. The method of claim 38, wherein said proxy network coordinator receives said consolidate message and reconfigures said hierarchical structure to consolidate data loads.

40. The method of claim 26, wherein said activating further comprises activating numbers of proxy servers and tiers to provide a predetermined network operating condition.

41. The method of claim 40 wherein said predetermined network operating condition comprises reduced network congestion.

42. The method of claim 40, wherein said predetermined network operating condition comprises minimum network bandwidth to provide said data stream to users.

43. The method of claim 26, wherein said users have a population and a distribution relative to the proxy servers of said overlay network, and said activating comprises activating proxy servers according to said population and distribution of users.

44. The method of claim 43 further comprising predicting an expected population and distribution of users for a predetermined period of time, and forming said hierarchical structure in anticipation of data loads of said population and distribution.

45. The method of claim 26 further comprising activating proxy servers to form another hierarchical structure comprising multiple tiers of proxy servers with respect to another data stream to distribute said other data stream to another plurality of users, said other hierarchical structure sharing one or more proxy servers with said first-mentioned hierarchical structure.

46. The method of claim 45 further comprising dynamically reconfiguring said other hierarchical structure as said other users change, said other hierarchical structure being dynamically reconfigured independent of said first-mentioned hierarchical structure.
